(19) United States
(12) Patent Application Publication
(10) Pub. No.: US 2014/0017382 A1
(43) Pub. Date: Jan. 16, 2014

(54) AERATED FOOD PRODUCTS COMPRISING A PROTEIN-BASED REVERSIBLE GEL

(71) Applicants: Zeynel Deniz Gunes, Lausanne (CH); Jin-Mi Jung, Beauvais (FR); Hans Jorg Werner Limbach, Epalinges (CH); Christophe Joseph Etienne Schmitt, Servion (CH)

(72) Inventors: Zeynel Deniz Gunes, Lausanne (CH); Jin-Mi Jung, Beauvais (FR); Hans Jorg Werner Limbach, Epalinges (CH); Christophe Joseph Etienne Schmitt, Servion (CH)

(73) Assignee: NESTEC S.A., Vevey (CH)

(21) Appl. No.: 14/008,889

(22) PCT Filed: Mar. 19, 2012
(86) PCT No.: PCT/EP2012/054776

§ 371 Date: Sep. 30, 2013

(30) Foreign Application Priority Data
Mar. 29, 2011 (EP) 11160150.6

(51) Int. Cl. A23G 9/38

(52) U.S. Cl. CPC A23G 9/38
USPC 426/565; 426/573

(57) ABSTRACT

The present invention relates to aerated food products with improved stability and texture comprising protein fibrils and monovalent salt. The products are characterized by the presence of a reversible gel.

### FIELD OF THE INVENTION

The present invention relates to aerated food products comprising a reversible gel, in particular frozen aerated food products such as ice cream.

### BACKGROUND OF THE INVENTION

Stability against coarsening, drainage and phase separation is a major problem for many aerated food products, for example frozen aerated food products such as ice cream, in particular when it is desired to avoid the use of synthetic emulsifiers.

Proteins have been used as agents to stabilize aerated food products, where they can act as emulsifiers, surface active agents and/or bulking agents to stabilize emulsions and foams. When using proteins as stabilizing agents, a problem is to have products that combine nutritional value, sufficient foam stability and good texture.

WO 2004/049819 describes the use of protein fibrils derived from β-lactoglobulin in the preparation of food stuffs, such as dairy products, for example (aerated) desserts, yogurts, flans, in bakery or confectionary applications, such as frappe, meringue, marshmallows, in cream liqueurs or in beverage foamers, such as cappuccino foamers. Each of the food stuff examples disclosed the presence of relatively high levels of divalent cations, particularly, calcium.

WO 2008/0446732 relates to a frozen aerated food product comprising surface active fibres which have an aspect ratio of 10 to 1000. The fibres exemplified are made of a food grade waxy material, such as carnauba wax, shellac wax or bee wax.

Surprisingly we have now found that aerated food products comprising protein fibrils prepared using a certain amount of monovalent salts, rather than divalent cations, have advantageous properties. In particular, we have found that such aerated food products comprise a reversible gel and so are more stable, particularly to thermal and/or mechanical stress.

### SUMMARY OF THE INVENTION

The present invention provides an aerated food product, comprising from 0.001 to 1.5, preferably 0.05 to 1.5, more preferably 0.2 to 1.5, most preferably 0.5 to 1.5 wt % of protein fibrils and from 0.01 to 0.2 mol/L of monovalent salt, wherein said aerated food product comprises a reversible gel. Said reversible gel is obtainable by first heating a protein solution containing from 0.1 to 5 wt % of globular protein, for 30 minutes to 48 hours at a temperature from 60° to 100° C. and a pH below 2.5 to produce protein aggregates in the form of fibrils, and then in any order, optionally mixing the fibrils with an aqueous salt solution or with salt in powder, at a pH of from 2.5 to 8 and diluting to provide 0.001 to 1.5, preferably 0.05 to 1.5, more preferably 0.2 to 1.5, most preferably 0.5 to 1.5 wt % of protein fibers in the food product.

### DETAILED DESCRIPTION OF THE INVENTION

The present invention relates to aerated food products which comprise a reversible gel. By “reversible gel” is meant any type of gel structure which is able to flow smoothly without fracturing in a sharp and irregular manner and to recover its initial form when subjected to prolonged shear. In contrast, irreversible gels that have a modulus high enough to maintain their shape without flowing, tend to display fractures, as they are pressed against mechanically (e.g. with a spoon). Once fractured, the gel structure is not recovered. In particular, for irreversible gels that are based on protein aggregates bound by divalent cations such as calcium cations, they display a strong irreversible thinning upon the application of a sustained flow protocol. A sustained flow protocol is one that consists in applying a flow with characteristic shear rates of a least 10/s for at least 1 hour. By “strong irreversible thinning” is meant a significant and persistent decrease of the shear viscosity in rotation in a window of shear rates including 1/s to 10/s, due to the application of the sustained shear. The persistence of the shear viscosity decrease shows up to several hours or days after the application of the sustained shear protocol. In contrast, the application of a sustained shear protocol to a reversible gel does not lead to such persistent irreversible character. The shear viscosity is recovered rapidly in the window 1/s to 10/s, i.e. typically within few minutes.

The presence of a reversible gel in the products of the invention brings several advantages, first of all in terms of stability to mechanical stress, drainage and coarsening which facilitates handling and transportation of the products. An arrested gel state can however take between a few minutes to a few hours to be achieved. Owing to the thixotropic nature of the reversible gel, the recovery time (hence the dynamics leading to arrest) is a complex mechanism that can even depend on sample size, presence of small bubbles, possibility of any stress e.g. due to gravity. However in similar conditions the difference in the recovery time scale to an arrested state, between the reversible and irreversible gels subjected to a sustained shear protocol, is striking. The time scale difference is in general at least of an order of magnitude and it can reach several orders of magnitude. In addition it must be stressed that the achievement of an arrested state also depends on the recovery of the shear viscosity of the thixotropic material. A reversible gel recovers a higher viscosity much more rapidly than an irreversible gel as defined here.

From a texture standpoint, the products of the invention have been found to advantageously benefit from the gel structure without getting the usual “gelly” texture usually associated with e.g. the use of gums. Other advantages will be illustrated in the rest of the description and examples.

The reversible gel present in the products according to the invention is obtainable by first producing protein fibrils by heating a protein solution containing from 0.1 to 5 wt % of globular protein for 30 min to 48 hours, at a temperature from 60° to 100° C. and a pH below 2.5. Then, the fibrils are optionally mixed with an aqueous salt solution or with salt in powder at a pH of from 2.5 to 8 and diluted to provide 0.001 to 1.5, preferably 0.05 to 1.5, more preferably 0.2 to 1.5, most preferably 0.5 to 1.5 wt % of protein fibrils in the food product.

Preferably, no salt is added during the formation of protein fibrils.

Preferably, the divalent cation concentration in the food product is less than 0.017 mol/L.

Preferably, the aerated food product has an overrun of between 20% and 250%, based on the total weight of the aerated product. Overrun is defined as:

$$Overrun = \frac{( Volume of aerated product - Volume of mix )}{Volume of mix} \times 100$$

Preferably, the aerated food product is frozen, more particularly it may be selected from the group consisting of ice cream, sorbet, mellorine, frozen yoghurt, milk ice, slush, frozen beverage, milk shake and frozen dessert.

Preferably when the aerated food product is frozen, it further comprises 5 to 15% milk solids non fat, 0 to 20% fat, 5 to 30% a sweetening agent and from 0.1 to 3% of a stabilizer system.

Preferably the globular protein is selected from whey proteins, blood globulins, soy proteins, soluble wheat proteins, potato proteins, lupin proteins, canola proteins and pea proteins. We particularly prefer whey protein isolate and β-lactoglobulin.

Preferably, the fibrils are obtainable by heating a protein solution containing from 2 to 4% of the globular protein. Preferably, the protein solution is heated from 2 to 10 hours.

Preferably, the protein solution is heated at a temperature of from 80° C. to 98° C.

Preferably the protein solution is heated at a pH below 2. Preferably the pH is above 1.

Further to their formation, the fibrils are preferably treated at pH which is greater than 0.1 pH units from the isolectric point of the globular protein. More preferably the pH is 0.5, especially 1 pH units from the isoelectric point. For β-lactoglobulin, the pH at which the fibrils is treated is at a pH of from 2.5 to 4.5 or 5.5 to 8.0.

The aerated food product comprises from 0.01 to 0.2 mol/L of monovalent salt. Preferably, the fibrils are treated with an aqueous solution of NaCl or with salt in powder to provide a final concentration of from 0.02 to 0.15 mol/L of monovalent salt.

Analysis of salt contents in the end product can be done by analytical methods well known in the art. In particular Inductively Coupled Plasma Atomic Emission Spectroscopy (ICP-AES) is applicable for the analysis of nine nutritional elements ((calcium (Ca), copper (Cu), iron (Fe), potassium (K), magnesium (Mg), manganese (Mn), sodium (Na), phosphorus (P), and zinc (Zn)) in most of foods such as milk and cereals based products, beverages and powder beverages with cocoa, refrigerated meals, culinary products, petfoods and in raw materials such as added salts and tastemakers.

This method is similar to AOAC method 984.27 for infant formulae. In addition, it is validated on most of food matrices using ICP-AES equipments with different grating configurations (axial, radial and dual view systems) after sample digestion with different Microwave Digestion Systems (MDS), with automatic addition of internal standards and ionization buffer to compensate physical and chemical interferences and to correct long-term instrumental unstability.

### FIGURES

FIG. 1: is a TEM micrograph of beta-lactoglobulin fibrils obtained upon heat treatment (negative staining). (Scale bar represents 0.5 microns)

FIGS. 2a and 2b: are pictures of a system of reversible (2a), respectively irreversible (2b) gel as described in example 1A, respectively 1B in a gelled state.

FIGS. 3a and 3b: are pictures representing the flow of the system of reversible gel (3a), respectively irreversible gel (3b) as described in example 1A, respectively 1B upon moderate stress application.

FIG. 4a: is a picture representing the system of reversible gel according to example 1A, 2 hours after application of a sustained shear protocol

FIG. 4b: is a picture representing the system of irreversible gel according to example 1B, 1 day after application of a sustained shear protocol

The present invention is further illustrated by means of the following non-limiting examples.

### EXAMPLES

### Example 1

### The Difference between Reversible and Irreversible Gels

A. Reversible Gel that is Constitutive of the Bulk Stabilizing Matrix of Aerated Food Products, Including Ice-Cream.

1. A suspension of fibrils is adjusted to pH 7.0 and diluted to 0.75% w/w concentration is prepared using the conditions and operating steps described in the application, with more specifically an initial protein concentration of 2% w/w, with 75% conversion to fibrils, and 1 to 10 μm contour length of the fibrils. The pH was adjusted to 7.0 by using a 1 mol/L sodium hydroxide solution. The fibril concentration was decreased to 0.75% by use of demineralized water.

2. Sodium chloride was added to increase the monovalent salt concentration to 0.1 mol/L. The system was stirred in gentle conditions by magnetic stirring to allow achieving uniform salt concentration during around 20 seconds.

3. The system was left at rest whereby gel properties built in time for 10 hours. The gel linear shear mechanical properties could be measured using a standard Anton Paar Physica rheometer during the gel strengthening, using methods know to those skilled in the art. A significant modulus was already obtained after 10 minutes and the elastic modulus reached as high as 20 Pa after 1 hour. We took the ratio of linear elastic modulus to linear loss modulus as a measure of the degree of elasticity at a given time.

A remarkable property of the gel was its so called reversibility. It means first its ability to flow smoothly, without fracturing like a jelly would. It had weak gel properties, meaning that in a pot of height between of the order of 5 cm or more, it flowed under its own weight. The flow was smooth meaning that it displayed no lump formation or no irregular features other than what is expected for strongly shear-thinning materials.

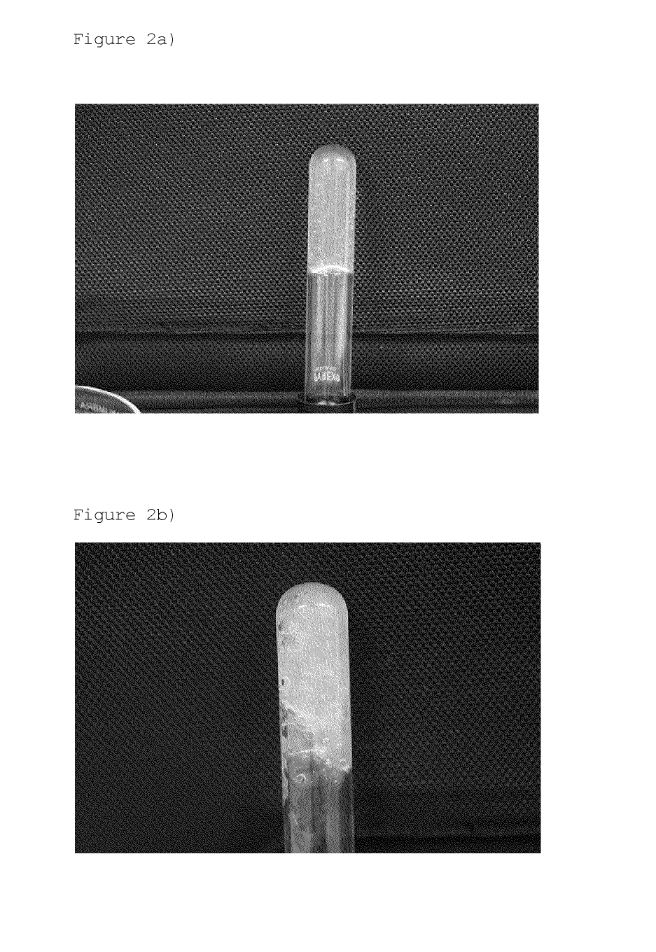

FIG. 2a) pictures the system of reversible gel in gelled (arrested) state in an assay tube, put upside down. The gel does not flow below a certain critical stress to be applied.

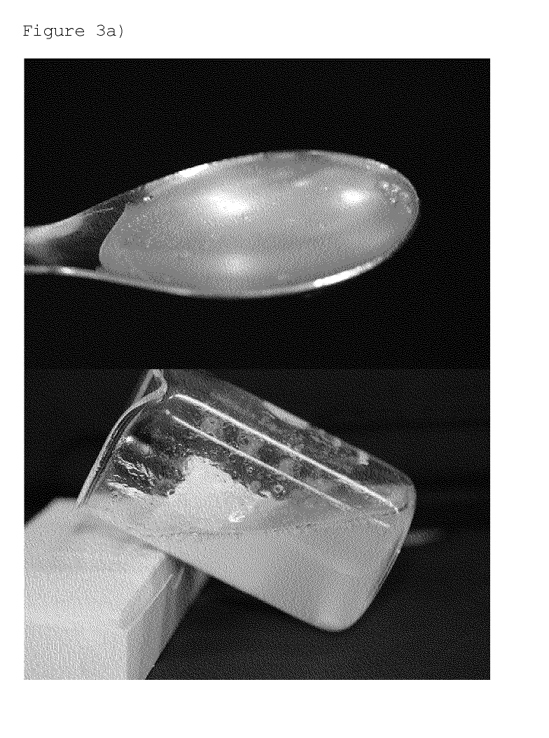

FIG. 3a) pictures the system of reversible gel, after flow by application of moderate stresses over a short period (a few seconds) onto the system initially in a gelled (arrested) state. It can be stated that the flow was smooth, resulting in a final shape of the free surface of the gel which is smooth, and horizontal. Top: in a spoon. Bottom: in a beaker.

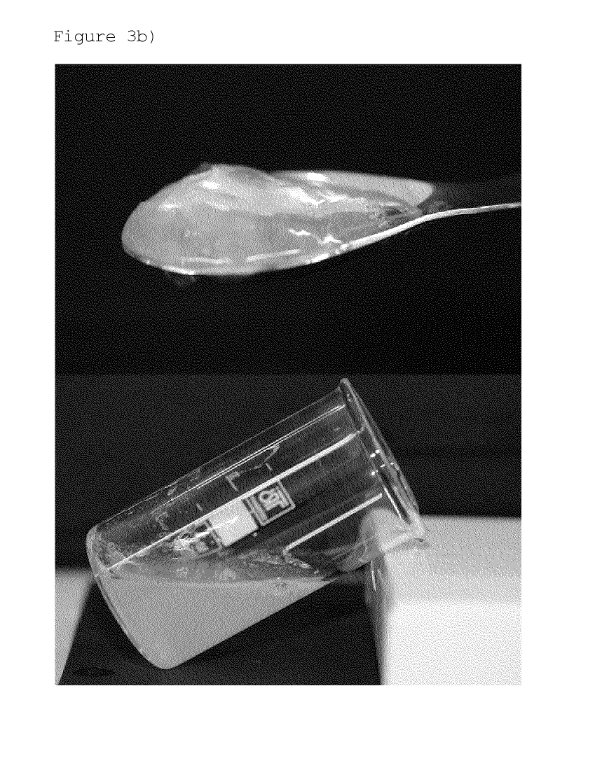

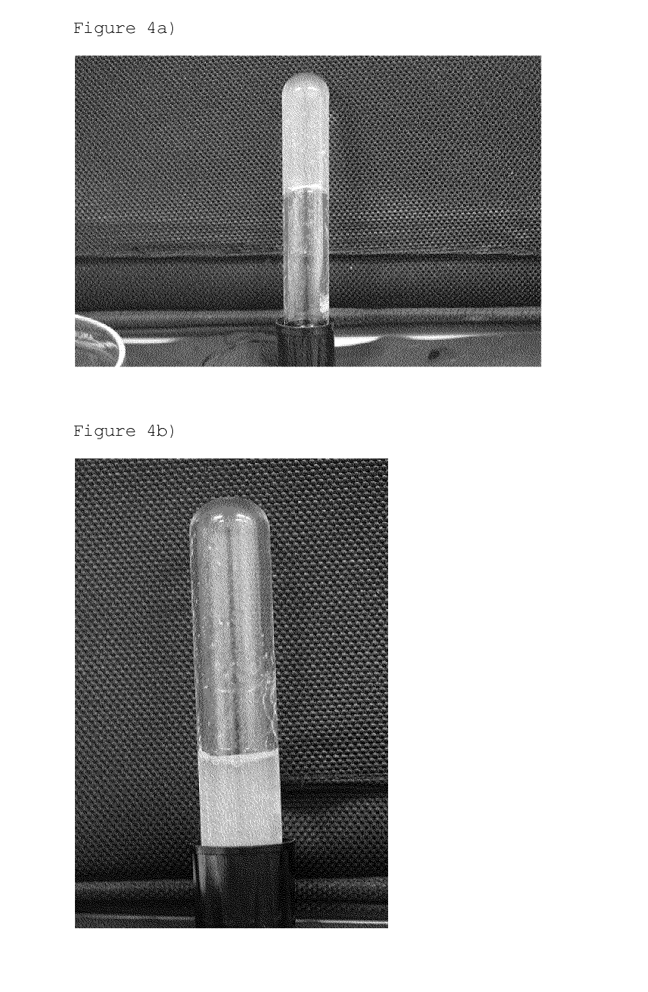

FIG. 4a) pictures the system of reversible gel, after 2 hours rest in an assay tube after a sustained shear protocol was applied while the system was in a beaker. The sustained shear protocol was as follows: the system was initially in a gelled (arrested) state in beaker with a magnetic stirrer at the bottom; magnetic stirring (typical shear rate of 10-20/s) was applied during 1 hour. The resulting system then became liquid, and part of it was inserted into the assay tube. In the case of the reversible gel, the system recovered its gel properties (arrested state) within less than 2 hours, since there was no flow observed upon putting the tube upside down.

B. An Irreversible Gel Prepared with Divalent (Calcium) Ions

1. A suspension of fibrils with pH 7.0 and 0.75% w/w concentration is prepared using the conditions and operating steps described in the application, with more specifically an initial protein concentration of 2% w/w, with 75% conversion to fibrils, and 1 to 10 μm contour length of the fibrils. The pH was adjusted to 7.0 by using a 1 mol/L sodium hydroxide solution. The fibril concentration was decreased to 0.75% by use of demineralized water.

2. Calcium dichloride was added to achieve a concentration of 0.03 mol/L. The system was stirred in gentle conditions by magnetic stirring to allow achieving uniform salt concentration, during around 20 seconds.

It can be noted that the corresponding increase in ionic strength is 0.09 mol/L if there was no binding of the calcium ions to anionic groups. The ionic strength in the solution would then be of 0.1 mol/L which is the same value as for the example A with monovalent salt.

Without being bound by theory, it is believed that divalent cations bind more irreversibly on anionic sites of protein structures, hence inducing a more irreversible type of aggregation than monovalent salts when used with protein fibrils. This is believed to be a cause of the irreversible character of the gel.

FIG. 2b) pictures the system of irreversible gel in gelled (arrested) state in an assay tube, put upside down. The gel does not flow below a certain critical stress to be applied.

FIG. 3b) pictures the system of irreversible gel, after flow by application of moderate stresses over a short period (a few seconds) onto the system initially in a gelled (arrested) state. It can be stated that the system then displays irregular features (like a jelly would), i.e. inhomogeneous flow properties. It is not able to flow smoothly, which results in shapes on the spoon and in the beaker which are not smooth. Top: on a spoon. Bottom: In a beaker.

FIG. 4b) pictures the system of irreversible gel, after 1 day rest in an assay tube after a sustained shear protocol was applied while the system was in a beaker. The sustained shear protocol was the same as applied to the reversible gel (see above). There is one difference which is that in the case of the irreversible gel, after application of the sustained-shear protocol and insertion into an assay tube, the system was left to rest 1 day. It was then put upside down and the system did flow immediately and accumulated near the cap, showing that the system was not able to recover its gel properties even over 1 day. It hence demonstrates that the system is indeed an irreversible gel.

### Example 2

### Ice Cream Comprising a Reversible Gel

Preparation

Two separate mixes were prepared for the ice cream preparation. The first mix (ice cream mix), contained all ingredients except the beta-lactoglobulin. The second mix, (protein fibril solution), contained the beta-lactoglobulin and underwent a separate heat treatment in order to produce the fibrils.

Ice Cream Mix Preparation
Mix all ingredients with water at T=60° C.
Keep mix at T=60° C. and let all ingredients hydrate for 2 hours.
The mix is then run through a pasteurization/homogenization line. Pasteurization is done at 86° C. for 30 seconds. Homogenization is done with a high pressure homogenizer (APV, type: APV-mix) with two stages at 140 and 40 bars respectively.
The mix is then kept at T=4° C. in order to maturate for 12 to 20 hours.

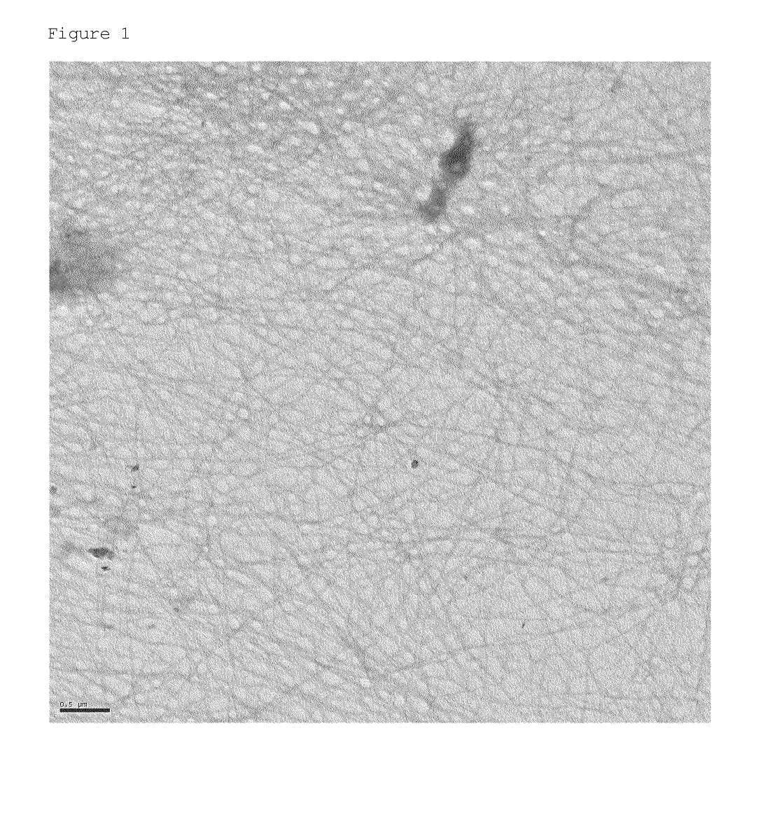

Reversible Gel Comprising Protein Fibrils
β-Lactoglobulin isolate and water are mixed at room temperature and the pH is adjusted to 2 with concentrated HCl.
The solution is rapidly heated under gentle steering to T=90° C. and kept at that temperature for 5 hours.
The solution is rapidly cooled and then stored at T=4° C. Samples are taken to prove the aggregation status of the rods with help of electron microscopy, as shown in FIG. 1 which is a TEM micrograph of beta-lactoglobulin fibrils obtained upon heat treatment (negative staining)*
The conversion rate** into protein fibrils for this process is 75%.
Option a): the pH is adjusted to 6.7 by addition of NaOH
Option b): NaCl is added at a pH of 6.7 in order to increase the monovalent salt (NaCl) concentration by 30 mM in the end product.

* Transmission Electron Microscopy (TEM)

A drop of the diluted solution (1-0.1% final wt concentration) was casted onto a carbon support film on a copper grid. The excess solution was removed after 30 seconds using a filter paper. Contrast to electrons was achieved by negative staining by adding a droplet of Phosphotungstic acid solution 1% (PTA, pH 7, Sigma-Aldrich, Switzerland) onto the grid, during 15 seconds, after deposition of b-lactoglobulin aggregates solution. Any excess of staining agent was removed again by a filter paper. Electron micrographs were acquired on a CCD camera using a Philips CM100 Biotwin Transmission Electron Microscope operating at 80 kV.

** Conversion Rate

The initial concentration of native b-lactoglobulin was checked by UV/vis-spectroscopy at 278 nm, using a Uvikon 810 spectrophotometer (Kontron Instruments, Flowspec, Switzerland). The extinction coefficient for the calibration was determined experimentally using known concentrations of b-lactoglobulin solutions at pH 2.0, where the b-lactoglobulin is present as monomer. The determined value, E278 =0.8272 L.cm-1.g-1 is in agreement with the literature.

The conversion rate was determined by UV/vis-spectroscopy at 278 nm. The heat-treated solution was diluted with MilliQ water and precipitated at pH 4.6, centrifuged at 22000 g during 15 min at 20° C. using Sorvall Evolution RC High Speed Centrifuge. The absorbance of the supernatant was read at 278 nm, yielding the concentration of non-aggregated b-lactoglobulin. The difference between the initial b-lactoglobulin concentration and the non-aggregated b-lactoglobulin concentration gives the amount of aggregated b-lactoglobulin, its ratio over the initial concentration being referred as the conversion yield.

Ice Cream Production
The ice cream mix and gel are mixed together under slow stirring in a vessel at T=4° C. The total monovalent salt concentration was 0.046 mol/L in option a) and 0.76 mol/L in option b) measured by ICP-AES. The total divalent cations concentration was 0.013 and 0.012 mol/L in option a), respectively option b) measured by the same analytical method.
The ice cream is produced in a Hoyer freezer (Technohoy MF 50). The outlet temperature is set to −5° C., the back pressure to 1.5 bars and the dasher speed to 500 rpm.
The ice cream is filled into 120 ml plastic cups. Recipe
1. Test Ice cream
(i) Ice cream mix:

| | Mass |
|---|---|
| Ingredient | [wt %] |
| Water | 45.835 |
| Dried glucose syrup (DE 40) | 16.191 |
| Sucrose | 13.247 |
| Coconut fat | 10.745 |
| Lactose | 7.860 |
| Skim milk powder | 3.238 |
| Dextrose monohydrate | 2.208 |
| Emulsifier / Stabilizer | 0.677 |

(ii) Protein fibril solution

| | Mass |
|---|---|
| Ingredient | [wt %] |
| Water | 96.154 |
| Beta Lactoglobulin Isolate | 3.846 |

Relative proportions of ice cream mix and protein fibril solutions were ⅔, respectively ⅓. The amount of fibrils in the end product was 0.95wt %.

1. An aerated food product, comprising from 0.001 to 1.5 of protein fibrils, from 0.01 to 0.2 mol/L of monovalent salt, a
reversible gel obtained by heating a protein solution containing from 0.1 to 5 wt % of globular protein,
for 30 min to 48 hours,
at a temperature from 60° to 100° C. and,
a pH below 2.5
to produce protein aggregates in the form of fibrils,
and then
mixing the fibrils with an aqueous salt solution or with salt in powder, at a pH of from 2.5 to 8 and
diluting to provide 0.001 to 1.5 of protein fibers in the food product.

2. An aerated food product according to claim 1, wherein no salt is added during the formation of protein fibrils.

3. An aerated food product according to claim 1, wherein the final divalent cation concentration is less than 0.017 mol/L.

4. An aerated food product according to claim 1, having an overrun of between 20% and 250%.

5. An aerated food product according to claim 1, which is frozen.

6. An aerated food product according to claim 5 selected from the group consisting of ice cream, sorbet, mellorine, frozen yoghurt, milk ice, slush, frozen beverage, milk shake and frozen dessert.

7. An aerated food product according to claim 5 comprising 5 to 15% milk solids non fat, 0 to 20% fat, 5 to 30% a sweetening agent and from 0.1 to 3% of a stabilizer system.

8. An aerated food product according to claim 1, wherein the globular protein is selected from the group consisting of whey proteins, blood globulins, soy proteins, soluble wheat proteins, potato proteins, lupin proteins, canola proteins and pea proteins.

9. An aerated food product according to claim 8, wherein the globular protein is β-lactoglobulin or whey protein isolate.

10. An aerated food product according to claim 1, wherein the reversible gel is obtained by heating a protein solution containing from 2 to 4% of the globular protein.

11. An aerated food product according to claim 1, wherein the protein solution is heated from 2 to 10 hours.

12. An aerated food product according to claim 1, wherein the protein solution is heated at a temperature of from 80° C. to 98° C.

13. An aerated food product according to claim 1, wherein the protein solution is heated at a pH of less than 2.

14. An aerated food product according to claim 1, wherein the fibrils are treated at a pH which is greater than 0.1 pH units from the isolectric point of the globular protein.

15. An aerated food product according to claim 1, wherein the fibrils are treated with an aqueous solution of monovalent salt to provide the food product with 0.02 to 0.15 mol/L of monovalent salt.
